(19) United States
(12) Patent Application Publication
(10) Pub. No.: US 2025/0314097 A1
(43) Pub. Date: Oct. 9, 2025

(54) BOTTOM OPENING PASSWORD LOCK

(71) Applicant: Zhihui CAI, Zhejiang (CN)

(72) Inventor: Zhihui CAI, Zhejiang (CN)

(21) Appl. No.: 18/673,356

(22) Filed: May 24, 2024

(30) Foreign Application Priority Data
Apr. 8, 2024 (CN) 202420706185.7

(51) Int. Cl. E05B 37/02; E05B 37/00

(52) U.S. Cl. CPC E05B 37/025; E05B 37/0058

(57) ABSTRACT

A bottom opening password lock comprises a lock case and a liner arranged in the lock case as well as a shackle connected with a top of the lock case, a lower cover is arranged on a lower side of the liner, and a locking mechanism and a password assembly are installed between the liner and the lower cover; the locking mechanism comprises a first bolt and a second bolt which are arranged correspondingly as well as a bolt pin arranged between the first bolt and the second bolt, and a bolt spring is installed on the bolt pin; the shackle is pressed down to make the forcing push head push clutch sleeves to move axially, thus the clutch sleeves and password wheels can be separated to realize code adjusting. The utility model is simple in structure and convenient to use.

### TECHNICAL FIELD

The utility model relates to the technical field of locks, and particularly to a bottom opening password lock.

### BACKGROUND OF THE INVENTION

A bottom opening password lock is a lock which is unlocked by arranging exposed password wheels at a bottom of a lock body and dialing the password wheels to a correct password in use, and is generally composed of a lock body, a shackle and a lock core assembly. The bottom opening password lock is widely used in real life. According to information and samples obtained from market and customers, a same type of password locks in the prior art have a serious security problem, that is, when a password is inaccurate, the password can be changed in case of entering several specific passwords.

For an existing bottom opening password lock, a code is adjusted by dialing a code adjusting block, resulting in that the password lock has a large number of parts, a complex assembly process and an unstable performance.

### BRIEF SUMMARY OF THE INVENTION

A technical problem to be solved by the utility model is to provide a bottom opening password lock with simple assembly and a small number of parts.

A technical solution adopted to solve the above technical problem in the utility model is as follows:

A bottom opening password lock comprises a lock case and a liner arranged in the lock case as well as a shackle connected with a top of the lock case, a lower cover is arranged on a lower side of the liner, and a locking mechanism and a password assembly are installed between the liner and the lower cover;

The locking mechanism comprises a first bolt and a second bolt which are arranged correspondingly as well as a bolt pin arranged between the first bolt and the second bolt, and a bolt spring is installed on the bolt pin;

The shackle is a U-shaped bar, and clamping grooves adapted to the first bolt and the second bolt are correspondingly arranged in an inner side of the shackle; convex keys are arranged symmetrically up and down on middle parts of clutch sleeves, a flat portion is arranged on one side of each driving part, a curved portion is arranged on the other side of the driving part, a limiting bulge is arranged on the flat portion, and a notch is arranged in the curved portion;

A rectangular fixing groove used for installing a positioning resilient piece is arranged in a middle part of the liner, and liner bulges matched with the notches of the clutch sleeves are arranged below the fixing groove; the password assembly comprises a pin shaft as well as multiple clutch sleeves, multiple password wheels, a code adjusting block and a code adjusting spring sheathed on the pin shaft, and a small frame and the positioning resilient piece which are arranged correspondingly;

An end part is arranged on an upper part of the small frame, a connecting hole corresponding to a hanging hole is arranged in a middle part, four legs are arranged on a lower part, and the legs are uniformly distributed between the password wheels; the password wheels are installed on the clutch sleeves, engaging parts adapted to the convex keys are arranged in middle parts of the password wheels, the engaging parts are matched with the convex keys to make the password wheels drive the clutch sleeves to rotate; the code adjusting block is installed on one side of the password wheels, and the code adjusting spring is installed on the other side;

The lower cover is clamped on a lower side of the liner, four rectangular wheel dialing holes adapted to the password wheels are arranged in a lower side of the lower cover, and the code adjusting block is sheathed on the pin shaft;

A forcing push head is arranged on a bottom of the shackle, a notch matched with the pin shaft is arranged in the forcing push head, and bevels matched with the code adjusting block are arranged on one side of the forcing push head.

Preferably, the number of the clutch sleeves and the password wheels is four, respectively, and each clutch sleeve is composed of a sleeve and the driving part.

Preferably, the clamping grooves are V-shaped grooves.

Preferably, the positioning resilient piece is in a flaked structure with a bent middle part and is installed on the liner through the fixing groove, four branch plates are arranged on a lower end of the positioning resilient piece, and lower ends of the branch plates are abutted against the password wheels.

Preferably, a small frame spring is installed between the connecting hole and the hanging hole.

Compared with the prior art, the forcing push head is arranged on the bottom of the shackle in the bottom opening password lock of the utility model, and the bevels are arranged on one side of the forcing push head; when code adjusting is needed, the shackle is rotated to make the bevels face to the code adjusting block, the shackle is pressed down to make the forcing push head push the clutch sleeves to move axially, thus the clutch sleeves and the password wheels can be separated to realize code adjusting. The utility model is simple in structure and convenient to use.

### BRIEF DESCRIPTION OF THE DRAWINGS

FIG. 1 is a three-dimensional schematic diagram of a bottom opening password lock of the utility model.

FIG. 2 is a local exploded view of a bottom opening password lock of the utility model.

FIG. 3 is an exploded view of a bottom opening password lock of the utility model.

FIG. 4 is a sectional view of a bottom opening password lock of the utility model.

FIG. 5 is a structural schematic diagram of a clutch sleeve of a bottom opening password lock of the utility model.

### DETAILED DESCRIPTION OF THE INVENTION

The utility model is further described below in detail in combination with the drawings and embodiments.

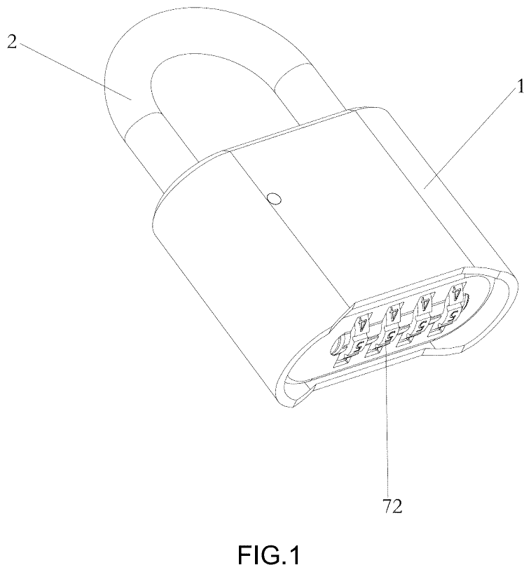

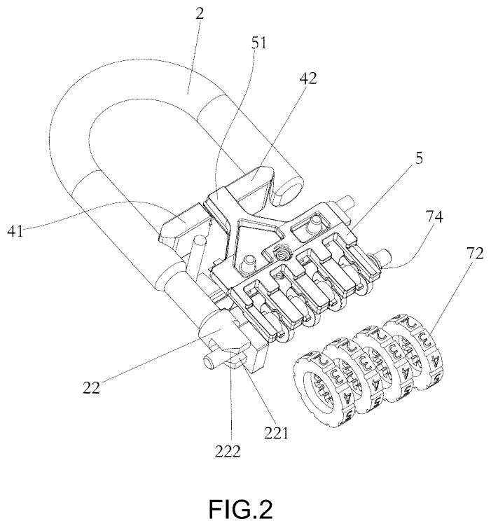

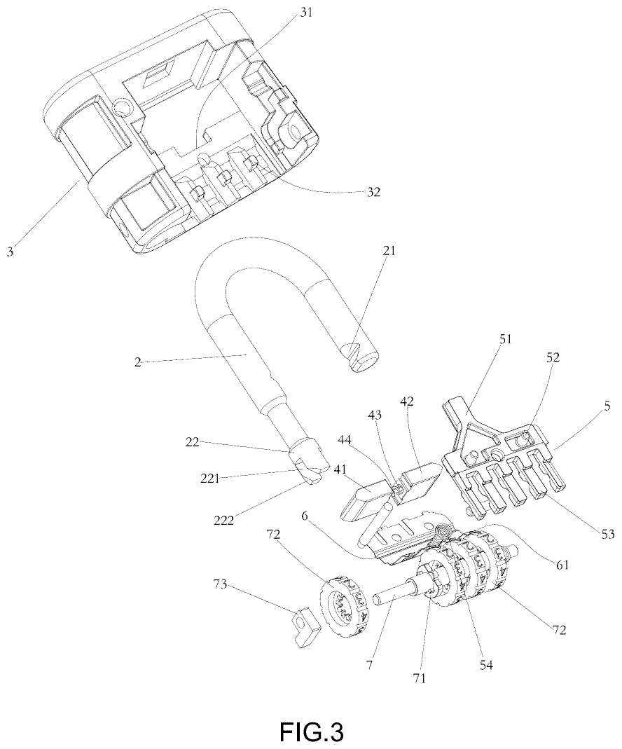

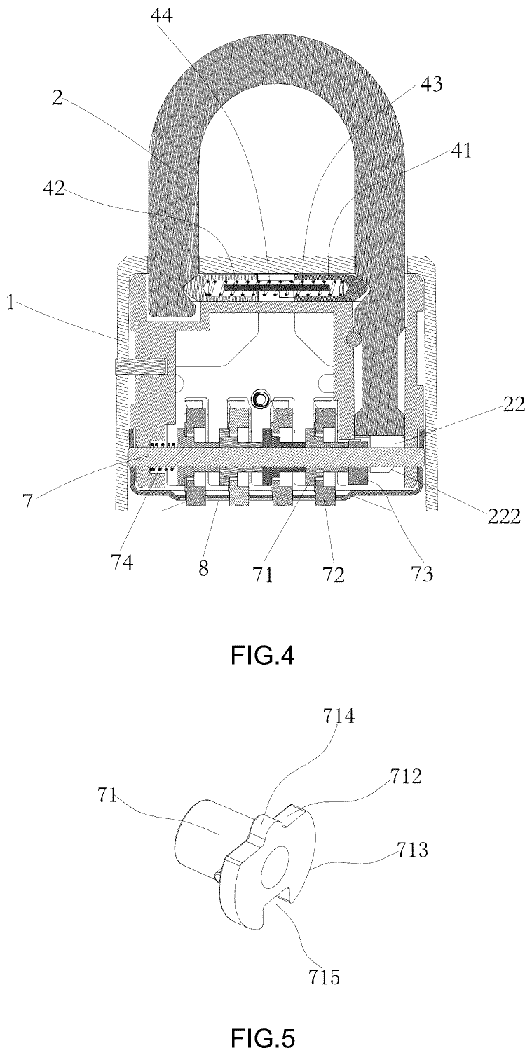

As shown in FIG. 1 to FIG. 5, a bottom opening password lock comprises a lock case 1 and a liner 3 arranged in the lock case 1 as well as a shackle 2 connected with a top of the lock case 1, a lower cover 8 is arranged on a lower side of the liner 3, and a locking mechanism and a password assembly are installed between the liner 3 and the lower cover 8.

The locking mechanism comprises a first bolt 41 and a second bolt 42 which are arranged correspondingly as well as a bolt pin 43 arranged between the first bolt 41 and the second bolt 42, and a bolt spring 44 is installed on the bolt pin 43.

The shackle 2 is a U-shaped bar, and clamping grooves 21 adapted to the first bolt 41 and the second bolt 42 are correspondingly arranged in an inner side of the shackle 2; a forcing push head 22 is arranged on a bottom of the shackle 2, a notch 221 matched with the pin shaft 7 is arranged in the forcing push head 22, and bevels 222 are arranged on one side of the forcing push head 22; the clamping grooves 21 are V-shaped grooves.

A rectangular fixing groove 31 used for installing a positioning resilient piece 6 is arranged in a middle part of the liner 3, and liner bulges 32 matched with notches 715 of clutch sleeves 71 are arranged below the fixing groove 31. The password assembly comprises a pin shaft 7 as well as multiple clutch sleeves 71, multiple password wheels 72, a code adjusting block 73 and a code adjusting spring 74 sheathed on the pin shaft 7, and a small frame 5 and the positioning resilient piece 6 which are arranged correspondingly. In the present embodiment, the number of the clutch sleeves 71 and the password wheels is four, respectively. Specifically, each clutch sleeve 71 is composed of a sleeve and a driving part. Convex keys 711 are arranged symmetrically up and down on middle parts of the clutch sleeves 71, a flat portion 712 is arranged on one side of each driving part, a curved portion 713 is arranged on the other side of the driving part. A limiting bulge 714 is arranged on the flat portion 712, and a notch 715 is arranged in the curved portion 713.

An end part 51 is arranged on an upper part of the small frame 5, a connecting hole 52 corresponding to a hanging hole is arranged in a middle part, four legs 53 are arranged on a lower part, and the legs 53 are uniformly distributed between the password wheels 72; Specifically, a small frame spring 54 is installed between the connecting hole 52 and the hanging hole, and the small frame spring 54 here is used for securing relative positions of the small frame 5, the positioning resilient piece 6 and the liner 3.

The password wheels 72 are installed on the clutch sleeves 71, engaging parts adapted to the convex keys 711 are arranged in middle parts of the password wheels 72, the engaging parts are matched with the convex keys 711 to make the password wheels 72 drive the clutch sleeves 71 to rotate. The code adjusting block 73 is installed on one side of the password wheels 72, and the code adjusting spring 74 is installed on the other side.

The positioning resilient piece 6 is in a flaked structure with a bent middle part and is installed on the liner 3 through the fixing groove 31, four branch plates 61 are arranged on a lower end of the positioning resilient piece 6, and lower ends of the branch plates 61 are abutted against the password wheels 72 to prevent the password wheels 72 from rotating arbitrarily during dialing.

The lower cover 8 is clamped on a lower side of the liner 3, four rectangular wheel dialing holes adapted to the password wheels 72 are arranged in a lower side of the lower cover 8, and the code adjusting block 73 is sheathed on the pin shaft 7.

Unlocking process: when the password wheels 72 are adjusted to four correct password digits, the notches 715 of the curved portions 713 of the clutch sleeves 71 are corresponding to the liner bulges 32; at this time, the flat portions 712 of four clutch sleeves 71 are adjusted to the same plane and fitted with the plane of the legs 53 on the lower part of the small frame 5, the legs 53 are rotated inward to drive the end part 51 of the small frame 5 away from the bolt pin 43 and make the end part 51 of the small frame 5 rotated out between the first bolt 41 and the second bolt 42, the bolts are separated from the clamping grooves 21 of the shackle 2, and then the shackle 2 can be pulled out for unlocking; when any one of the four password digits is incorrect, the notches 715 of the curved portions 713 of the clutch sleeves 71 cannot be corresponding to the liner bulges 32 one to one; at this time, the flat portions 712 of the clutch sleeves 71 cannot be adjusted to the same plane and cannot be fitted with the plane of the legs 53 on the lower part of the small frame 5, so that the end part 51 of the small frame 5 cannot be rotated out between the first bolt 41 and the second bolt 42, and the bolts are clamped by the clamping grooves 21 and cannot be unlocked.

Code adjusting process: first, the four password digits are adjusted to a correct password, the shackle 2 is rotated by 180° to make the bevels 222 of the forcing push head 22 face to the code adjusting block 73, and the shackle 2 is pressed to make the bevels 222 of the forcing push head 22 push the code adjusting block 73 to move rightward; at this time, the code adjusting block 73 in the lock case 1 is moved rightward to push the clutch sleeves 71 and make the convex keys 711 of the clutch sleeves 71 separated from the engaging parts of the password wheels 72; at this time, the password can be reset by dialing the password wheels 72. After password reset is completed, the shackle 2 is rotated by 180° to make the bevels 222 of the forcing push head 22 separated from the code adjusting block 73, and the code adjusting block 73 is reset under the force of the code adjusting spring 74.

To improve the potential security problem of the bottom opening password lock during code adjusting, i.e., the problem that the password can be changed when the password wheels 72 are dialed to corresponding digits on the other side of the correct password, including the problem that in actual operation, when a password of a same type of bottom opening password locks on the market is set to a combination of the three digits 4, 5 and 6, the clutch sleeves 71 can be pushed to change the password even if the password is not known.

The forcing push head 22 is arranged on the bottom of the shackle 2 in the bottom opening password lock of the utility model, and the bevels 222 are arranged on one side of the forcing push head 22; when code adjusting is needed, the shackle 2 is rotated to make the bevels 222 face to the code adjusting block 73, the shackle 2 is pressed down to make the forcing push head 22 push the clutch sleeves 71 to move axially, thus the clutch sleeves 71 and the password wheels 72 can be separated to realize code adjusting. The utility model is simple in structure and convenient to use.

Finally, it should be noted that the above embodiments are only used for describing the technical solution of the utility model rather than limitation. Although the utility model is described in detail by referring to the above embodiments, those ordinary skilled in the art should understand that: the technical solution recorded in each of the above embodiments can be still amended, or some technical features therein can be replaced equivalently. However, these amendments or replacements do not enable the essence of the corresponding technical solution to depart from the spirit and the scope of the technical solution of various embodiments of the utility model.

What is claimed is:

1. A bottom opening password lock, comprising a lock case (1) and a liner (3) arranged in the lock case (1) as well as a shackle (2) connected with a top of the lock case (1), a lower cover (8) is arranged on a lower side of the liner (3), and a locking mechanism and a password assembly are installed between the liner (3) and the lower cover (8);
the locking mechanism comprises a first bolt (41) and a second bolt (42) which are arranged correspondingly as well as a bolt pin (43) arranged between the first bolt (41) and the second bolt (42), and a bolt spring (44) is installed on the bolt pin (43);
the shackle (2) is a U-shaped bar, and clamping grooves (21) adapted to the first bolt (41) and the second bolt (42) are correspondingly arranged in an inner side of the shackle (2); convex keys (711) are arranged symmetrically up and down on middle parts of clutch sleeves (71), a flat portion (712) is arranged on one side of each driving part, a curved portion (713) is arranged on the other side of the driving part, a limiting bulge (714) is arranged on the flat portion (712), and a notch (715) is arranged in the curved portion (713);
a rectangular fixing groove (31) used for installing a positioning resilient piece (6) is arranged in a middle part of the liner (3), and liner bulges (32) matched with the notches (715) of the clutch sleeves (71) are arranged below the fixing groove (31);
the password assembly comprises a pin shaft (7) as well as multiple clutch sleeves (71), multiple password wheels (72), a code adjusting block (73) and a code adjusting spring (74) sheathed on the pin shaft (7), and a small frame (5) and the positioning resilient piece (6) which are arranged correspondingly;
an end part (51) is arranged on an upper part of the small frame (5), a connecting hole (52) corresponding to a hanging hole is arranged in a middle part, four legs (53) are arranged on a lower part, and the legs (53) are uniformly distributed between the password wheels (72); the password wheels (72) are installed on the clutch sleeves (71), engaging parts adapted to the convex keys (711) are arranged in middle parts of the password wheels (72), the engaging parts are matched with the convex keys (711) to make the password wheels (72) drive the clutch sleeves (71) to rotate; the code adjusting block (73) is installed on one side of the password wheels (72), and the code adjusting spring (74) is installed on the other side;
the lower cover (8) is clamped on a lower side of the liner (3), four rectangular wheel dialing holes adapted to the password wheels (72) are arranged in a lower side of the lower cover (8), and the code adjusting block (73) is sheathed on the pin shaft (7);
characterized in that a forcing push head (22) is arranged on a bottom of the shackle (2), a notch (221) matched with the pin shaft (7) is arranged in the forcing push head (22), and bevels (222) matched with the code adjusting block (73) are arranged on one side of the forcing push head (22).

2. The bottom opening password lock according to claim 1, wherein the number of the clutch sleeves (71) and the password wheels is four, respectively, and each clutch sleeve (71) is composed of a sleeve and the driving part.

3. The bottom opening password lock according to claim 1, wherein the clamping grooves (21) are V-shaped grooves.

4. The bottom opening password lock according to claim 1, wherein the positioning resilient piece (6) is in a flaked structure with a bent middle part and is installed on the liner (3) through the fixing groove (31), four branch plates (61) are arranged on a lower end of the positioning resilient piece (6), and lower ends of the branch plates (61) are abutted against the password wheels (72).

5. The bottom opening password lock according to claim 1, wherein a small frame spring (54) is installed between the connecting hole (52) and the hanging hole.
